(19) United States
(12) Patent Application Publication
(10) Pub. No.: US 2021/0405316 A1
(43) Pub. Date: Dec. 30, 2021

(54) FIBER OPTIC SPLICE TRAY

(71) Applicant: Corning Research & Development Corporation, Corning, NY (US)

(72) Inventor: Diana Rodriguez, Fort Worth, TX (US)

(21) Appl. No.: 17/472,940

(22) Filed: Sep. 13, 2021

Related U.S. Application Data
(63) Continuation of application No. PCT/US20/22216, filed on Mar. 12, 2020.
(60) Provisional application No. 62/827,319, filed on Apr. 1, 2019.

(51) Int. Cl. G02B 6/44

(52) U.S. Cl. CPC G02B 6/4454

(57) ABSTRACT

A fiber optic splice tray is provided including a first base and second base each having first face and a first splice organizer disposed on a first face of the first base and a second splice organizer disposed on the first face of the second base. The first and second splice organizers are configured to removably retain a first and second plurality of fiber optic splice connections respectively. The fiber optic splice tray also includes a first hinge feature disposed at an edge of the first base and a second hinge feature disposed on an edge of the second base. The first base is pivotally connected to the second base, such that the fiber optic splice tray is movable between an open position, in which the first side of the first base and the first side of the second base are accessible, and a closed position.

### PRIORITY APPLICATION

This application is a continuation of International Application No. PCT/US20/22216, filed on Mar. 12, 2020, which claims the benefit of priority to U.S. Application No. 62/827,319, filed on Apr. 1, 2019, both applications being incorporated herein by reference.

### FIELD

This disclosure generally pertains to fiber optic assemblies, and more particularly to a fiber optic splice tray.

### BACKGROUND

In fiber optic networks, fiber optic cables and optical fibers may be spliced to change cable types, such as when entering a building or changing environments. Additionally, fiber optic splices may be used when changing cable fiber density for routing purposes. A splice tray may be utilized to retain and protect the splice connections. Increases in demand for fiber optic communication may lead to increased fiber density with a corresponding increase in number of splice connections, which may exceed the capacities of some splice trays.

### SUMMARY

In some examples, fiber cables, such as 288 fiber cables, may have fiber densities beyond the current splice tray design, such as splice trays configured for 144 fibers, e.g. 12 12-fiber ribbons. Some installers may separate a 288 fiber cable, such as an outside plant cable into two 144 fiber portions and route each portion into a separate splice tray configured for 144 fibers. However, this method includes a split of the cable outside of the protective enclosure of the splice tray and can be cumbersome for making the splice connections and managing the fiber and splice trays. Alternatively, some installers may route all 288 fibers and associated splice connections through the splice tray configured for 144 fibers, which may result in a significant portion of the splice connectors not being properly retained in the splice tray. Additionally, routing of all 288 fibers into the splice tray may also cause overcrowding of the splice tray making fiber management and service difficult.

An embodiment of the disclosure is directed to a fiber optic splice tray. More particularly, a fiber optic splice tray having a first and second base portions each having a splice organizer. The first and second base portions are pivotally connected to each other, such that the splice tray is movable between an open position and a closed position, similar to a book or butterfly. In the open position, the splice holders and fiber management portions of both bases of the splice tray may be accessible. In the closed position, the splice organizer may be faced toward each other, such that a backplane of each base provides a protective enclosure to the splice connections within.

Some high fiber ribbon cables may include routable subunits of 288 fibers, such as 24 12-fiber ribbons per subunit. Previously, these sub units have been field furcated on both the inside and outside plant cables using a braided type tubing. However, the fiber optic splice tray discussed herein enables 288 fiber routable subunits to be routed directly into the splice tray without furcation. A subunit cable may be routed to a central portion of the open splice tray and allow the ribbons to be divided equally between the first and second base portions for splice connections. Dividing the ribbons enables easy fiber ribbon routing on each base portion consistent with industry standards. Additionally, the splice tray may be physically sized to fit inside existing fiber optic hardware assemblies with only minor or no modifications.

In an example embodiment, the splice tray may include a hinge plate disposed between the first base portion and the second base portion and the first and second base portions may include a fiber routing port disposed proximate to the hinge plate. The fiber routing ports may be complementary creating a common opening to route fiber cables through. The incoming 288 fiber subunit may be disposed on and/or restrained to, the hinge plate with ribbon portions fanned out to the first and second base portions for splice connection with the outgoing 144 fiber cable. The outgoing 144 fiber cables may be restrained to the first and second cable routing ports, such that when the splice tray is in the closed position all three cables extend from the common opening.

The hinges connecting the base portions and/or the hinge plate may include a plurality of receivers and a hinge pin, may be a living hinge, or may be other suitable pivotable hinge connection features. In some instances, the base portions may be directly connected to one another or may be connected via the above described hinge plate. In an example embodiment, the hinge plate may be formed as a portion of the first or second base plate.

Additional features and advantages will be set forth in the detailed description which follows, and in part will be apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a perspective view of prior art splice tray;

FIG. 2 illustrates an example fiber routing in the prior art splice tray of FIG. 1;

FIG. 3 illustrates an example splice tray according to an example embodiment;

FIG. 4 illustrates an exploded view of a splice tray according to an example embodiment;

FIG. 5 illustrates an example splice tray in a closed position according to an example embodiment; and

FIG. 6 illustrates an example splice tray in an open position according to an example embodiment.

The embodiments set forth in the drawings are illustrative in nature and not intended to be limiting of the scope of the detailed description or claims. Whenever possible, the same reference numeral will be used throughout the drawings to refer to the same or like feature. The drawings are not necessarily to scale for ease of illustration an explanation.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

### Definitions and Explanation of Select Terms

The following definitions and explanations regarding certain terms apply to the specification and claims that follow.

“Include,” “includes,” or like terms means encompassing but not limited to, that is, inclusive and not exclusive.

The indefinite article “a” or “an” and its corresponding definite article “the” as used herein means at least one, or one or more, unless specified otherwise.

FIG. 1 depicts a perspective view of a prior art splice tray 100. The splice tray 100 may include a base 101, or backplane, that may be generally planar. The splice tray 100 may include a flange 102, or lip, that extends outward from a periphery of the base 101. The flange 102 may be configured to restrict the movement of one or more fibers routed through the splice tray 100. In some example embodiment, the flange 102 may include a projection extending in a plane substantially parallel with the base 101 toward a central portion of the base 101. The flange 102 including the projection may be configured to retain the one or more fibers proximate to the base 101 by limiting or restricting movement of the fibers.

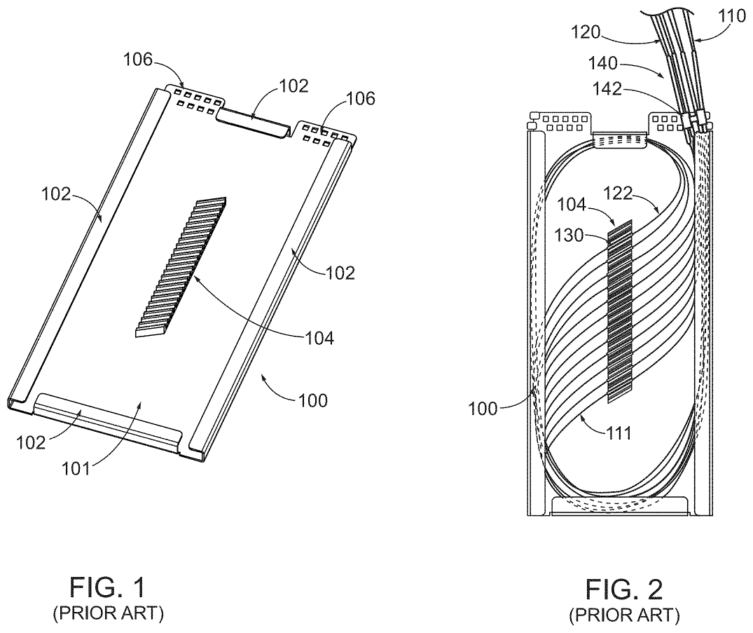

The splice tray 100 may include one or more splice organizers 104, or splice holders, the splice organizers 104 may be configured to removably retain a plurality of fiber optic splice connections. For example, the splice organizers may be configured to retain the fiber optic splice connections by a friction or interference fit. The splice tray 100 may also include one or more cable ports 106 configured to retain one or more fiber cables to the splice tray 100, as depicted in FIG. 2.

FIG. 2 illustrates cable/fiber routing in the prior art splice tray described in FIG. 1. A furcation tube 140 may be placed near a terminal end of one or more first cables 110 and one or more second cables 120. The furcation tubes 140 may delineate, such as by color, the type of cable. The furcation tubes 140 may be utilized to protect the relatively delicate optical fibers. The first cables 110 and second cables 120 may be restrained in the cable ports of the splice tray 100 by one or more cable ties 142. The first cables 110 and/or second cables 120 may be fiber optic cables or subunits of fiber optic cables. The distal ends of the fibers or ribbons 111 of the first cables and the distal ends of the second fibers or ribbons 122 may be spliced, such as fusion spliced, at a splice connection 130. The splice connections 130 may be removable retained by the splice organizers 104.

Routing of cables and/or subunits of cables having fiber density exceeding the design capacity of the splice tray 100 may cause over crowing of the splice tray 100 making servicing the splice connections 130 difficult. Additionally, the splice tray 100 may have insufficient positions in the splice organizers 104 resulting in unrestrained splice connections 130, which may risk damage or destruction of the splice connection 130. Alternatively, routing a cable with a fiber density exceeding the design capacity of the splice tray 100 to two separate splice trays may result in splice trays stacked on top of one another making service of the fibers difficult. Additionally, routing of a cable with fiber density exceeding the design capacity of the splice tray 100 to two separate splice trays requires dividing the fibers or ribbons 111 outside of the protection of the splice trays 100 increasing their susceptibility to damage.

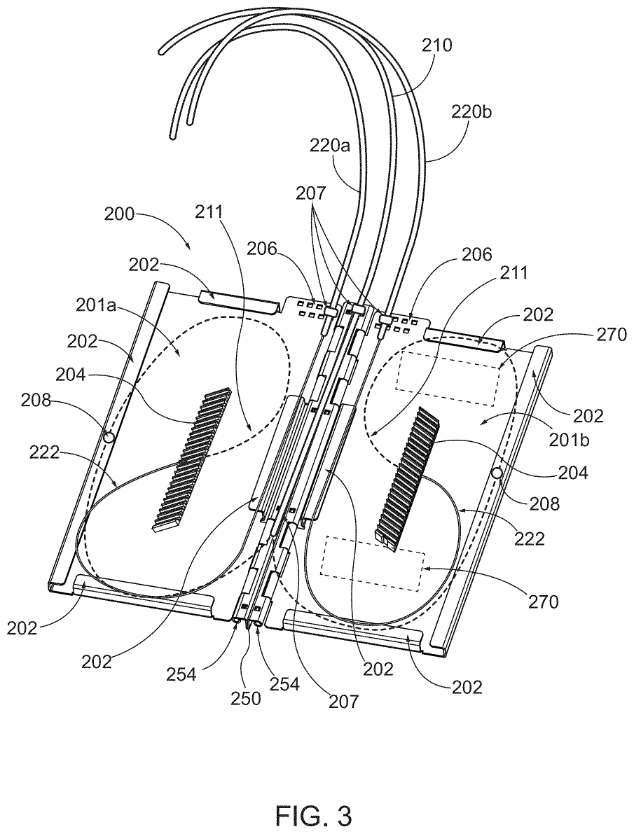

Turning to FIG. 3, a splice tray 200 is provided to accommodate high density fiber cables and subunits. The splice tray 200 may include a first base 201A and a second base 201B. The first base 201A and second base 201B may each include a splice organizer 204. The splice organizer 204 may be configured to removably retain a plurality of fiber optic splice connections. The first base 201A and second base 201B may also include flange 202, or lip, that extends outward from a periphery of the base 201A, 201B. The flange 202 may be configured to restrict the movement of one or more fibers or ribbons routed through the splice tray 200. In some example embodiments, the flange 202 may include a projection extending in a plane substantially parallel with the base 201A, 201B toward a central portion of the base 201A, 201B. The flange 202, including the projection, may be configured to retain the one or more fibers proximate to the base 201A, 201B by limiting or restricting movement of the fibers. The flange 202 may be disposed about at least a portion of the periphery of the base 201A, 201B. Further, the flange 202 may be continuous or may include a plurality of flange segments disposed along the periphery of the base 201A, 201B.

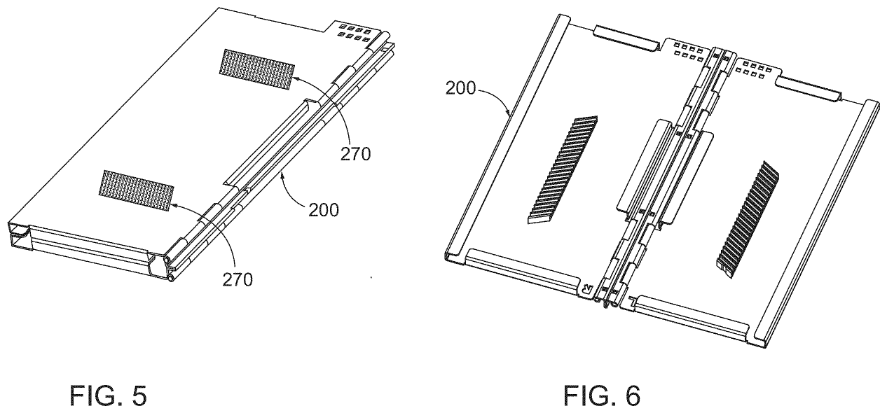

In an example embodiment, a hinge feature may be disposed between the first base 201A and the second base 201B, such that the fiber optic splice tray 200 is movable between an open position, as depicted in FIG. 6, and a closed position, as depicted in FIG. 5. In the open position a working face of the backplane of the bases 201A, 201B and the associated splice organizers 204 are accessible, such that a user may service the fiber, ribbons, or splice connections therein. In the closed position, the working face of the backplanes of the bases 201A and 201B may face inward toward each other limiting accessibility to the fiber, ribbon, or splice connections in the first and second bases 201A, 201B and providing a protective enclosure to the cables and fibers within.

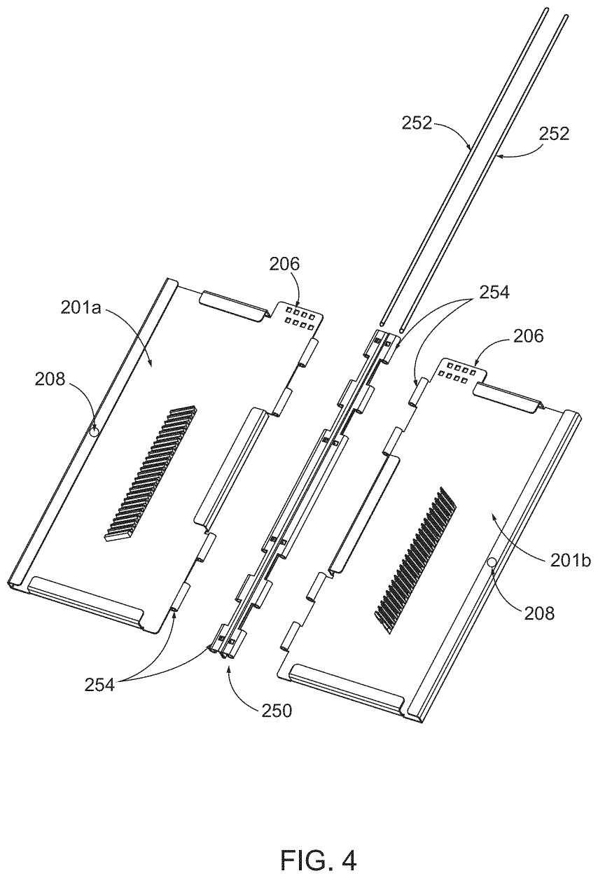

The hinge feature may include one or more complementary receivers and a hinge pin, may include a living hinge, and/or may include another suitable pivoting connection(s). In an example embodiment, the hinge feature may be disposed at adjacent edges of the first base 201 and second base 201B and directly connect the first base 201A to the second base 201B. In another embodiment, the splice tray 200 may include a hinge plate 250 and a plurality of hinge features 254, as illustrated in the example depicted in FIGS. 3-6. In the depicted example, the hinge plate 250 is disposed between the first base 201A and the second base 201B. A first hinge 254 is disposed between an edge of the first base 201A and an edge of the hinge plate 250. A second hinge feature 254 is disposed between an edge of the second base 201 and an edge of the hinge plate 250.

In an example embodiment, a first cable 210, or subunit, such as an outside plant cable subunit having 288 fibers, may be routed into the splice tray 200. One or more second cables 220, such as two inside plant cables having 144, also may be routed into the splice tray 200. In some embodiments the second cables 220 may have a braiding tubing disposed thereon. The fibers/ribbons 211 of the first cable 210 and the fibers/ribbons 222 of the one or more second cables 22 may be spliced together, such as a mass fusion splice. In some example embodiments, a splice protector, such as heat shrink, poly coating, or other suitable protective material, may be disposed about the splice connection. The splice connection including any protective material may be positioned in and/or restrained by the splice organizer 204.

In the depicted embodiment, the first cable 210 is routed to a center portion of the splice tray 200 defined by the hinge feature. The hinge plate 250 may include one or more retention features, such as apertures configured to receive a cable tie, tie wrap, or the like. A portion of the first cable 210 may be unjacketed and the exposed fiber/ribbon 222 may be separated into equal groups and routed to the first and second bases 201A, 201B. The jacketed portion of the first cable 210 may be routed along the hinge plate 250 to a predetermined position and restrained by one or more cable ties 207. The cable ties 207 may be fastened about a jacketed portion of the first cable 210, such that no furcation is necessary. Similarly, a portion of the one or more second cables 210 may be unjacketed. One or more second cables 220A may be routed into a cable port 207 of the first base 201A and another one or more second cables 220B may be routed through a cable port 207 of the second base 201B. A jacketed portion of the one or more second cables 220 may be restrained in the cable port by a cable tie 207, such that furcation of the second cables is also unnecessary. The cable ports 207 of the first and second bases 201A, 201B may be disposed proximate or adjacent to the hinge feature, such as the hinge plate 250, such that when the splice tray is in the closed position the cable ports 207 form a single common opening for routing the first cable 210 and the second cables 220.

In an example embodiment, flange segments proximate or adjacent to the hinge feature may be offset inward toward the center of the first base 201A and/or 201B, thereby providing a channel in the central portion of the splice tray for the first cable 210 when the splice tray 200 is in the closed position.

In some example embodiments, the splice tray 200 may include one or more closing features 208. The closing features 208 may include magnets, one or more latches, one or more clips, one or more hook and loop fasteners, or other suitable closures. The closing features 208 may be configured to retain the splice tray 200 in the closed position when not being serviced. In an example embodiment, the splice tray 200 may include one or more mounting features 270 configured to retain the splice tray 200 in a mounted position inside of a fiber optic hardware assembly, such as an internal wall of a closure or cabinet. The mounting features 270 may be disposed on an outer face of the splice tray 200 and may include without limitation, screw captures, hook and loop fasteners, double sided adhesive tape, or other suitable mounting feature.

The fiber optic splice tray discuss herein includes a first and second base portions each having a splice holder and pivotally connected to each other, such that the splice tray is movable between an open position and a closed position, similar to a book or butterfly. In the open position, the splice holders and fiber management portions of both bases of the splice tray may be accessible. This configuration enables fibers or ribbons of a high fiber density cable to be separated into two groups and spliced in separate trays with a manageable fiber routing scheme. The splice tray also enables the ingress and egress cables to be routed and restrained in the splice tray without furcation. Additionally, the first and second bases serve as a closure to the opposing base, when the splice tray is in the closed position, thereby adding further protection to the cables, fibers, and ribbons disposed therein.

In an example embodiment, a fiber optic splice tray is provided including a first base having first face and a first splice organizer disposed on a first face of the first base. The first splice organizer is configured to removably retain a first plurality of fiber optic splice connections. The fiber optic splice tray also includes a second base having a first face and a second splice organizer disposed on the first face of the second base. The first splice organizer is configured to removably retain a second plurality of fiber optic splice connections. The fiber optic splice tray also includes a first hinge feature disposed on an edge of the first base or second base. The first base is pivotally connected to the second base, such that the fiber optic splice tray is movable between an open position in which the first face of the first base and the first face of the second base are accessible and a closed position in which the first face of the first base confronts the first face of the second base face limiting accessibility to the first face of the first base and the first face of the second base.

In some example embodiments the fiber optic splice tray also includes a hinge plate and a second hinge feature disposed on a first edge of the hinge plate. The hinge plate is disposed between the first base and the second base and the first hinge feature pivotably connects the first base to the hinge plate and the second hinge feature pivotally connects the hinge plate to the second base. In an example embodiment, the first hinge feature pivotally connects the first base to the second base. In some example embodiments, the first base and the second base each include a flange disposed about at least a portion of one or more edges. The flange is configured to retain a plurality of fibers proximate to the first face of the first base and second base, respectively. In an example embodiment, the first base includes a first fiber routing port disposed adjacent to the first hinge feature and the second base comprises a second fiber routing port disposed complementary to the first cable entry port. In some example embodiments, the first fiber routing port or the second fiber routing port comprises one or more cable restraint apertures. In an example embodiment, the first plurality of fiber optic splice connections and the second plurality of fiber optic splice connections are mass fusion splices. In some example embodiments, the first plurality of fiber optic splice connections includes at least 144 splice connections and the second plurality of fiber optic splice connections comprises at least 144 splice connections. In an example embodiment, the first plurality of fiber optic splice connections includes splice connections between a first portion of a 288 fiber cable and a first 144 fiber cable and the second plurality of fiber optic splice connections comprises splice connections between a second portion of a 288 fiber cable and a second 144 fiber cable. In some example embodiment, the fiber optic splice tray also includes a closing feature configured to maintain the fiber optic splice tray in the closed position. In an example embodiment, the closing feature includes one or more magnets, one or more latching features, or one or more hook and loop fasteners.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A fiber optic splice tray comprising:
a first base having first face;
a first splice organizer disposed on the first face of the first base, wherein the first splice organizer is configured to removably retain a first plurality of fiber optic splice connections;
a second base having a first face;
a second splice organizer disposed on the first face of the second base, wherein the second splice organizer is configured to removably retain a second plurality of fiber optic splice connections; and
a first hinge feature disposed on an edge of the first base or second base,
wherein the first base is pivotally connected to the second base, such that the fiber optic splice tray is movable between an open position in which the first face of the first base and the first face of the second base are accessible and a closed position in which the first face of the first base confronts the first face of the second base limiting access to the first face of the first base and the first face of the second base.

2. The fiber optic splice tray of claim 1, further comprising:
a hinge plate; and
a second hinge feature disposed on a first edge of the hinge plate;
wherein the hinge plate is disposed between the first base and the second base, and wherein the first hinge feature pivotally connects the first base to the hinge plate and the second hinge feature pivotally connects the hinge plate to the second base.

3. The fiber optic splice tray of claim 2, wherein the first hinge feature is pivotally connected to the second hinge feature.

4. The fiber optic splice tray of claim 1, wherein the first base and the second base each comprise a flange disposed about at least a portion of one or more edges, wherein the flange is configured to retain a plurality of optical fibers proximate to the first face of the first base and the first face of the second base.

5. The fiber optic splice tray of claim 1, wherein the first base comprises a first fiber routing port disposed adjacent to the first hinge feature and the second base comprises a second fiber routing port disposed complementary to the first fiber routing port.

6. The fiber optic splice tray of claim 5, wherein the first fiber routing port or the second fiber routing port comprises one or more cable restraint apertures.

7. The fiber optic splice tray of claim 1, wherein the first plurality of fiber optic splice connections and the second plurality of fiber optic splice connections comprise mass fusion splices.

8. The fiber optic splice tray of claim 1, wherein the first plurality of fiber optic splice connections comprises at least 144 splice connections and the second plurality of fiber optic splice connections comprises at least 144 splice connections.

9. The fiber optic splice tray of claim 1 further comprising:
a 288 fiber cable having a first portion and a second portion;
a first 144 fiber cable spliced to the first portion of the 288 fiber cable to form the first plurality of fiber optic splice connections; and
a second 144 fiber cable splice to the second portion of the 288 fiber cable to form the second plurality of fiber optic splice connections.

10. The fiber optic splice tray of claim 1, further comprising a closing feature configured to maintain the fiber optic splice tray in the closed position.

11. The fiber optic splice tray of claim 10, wherein the closing feature comprises one or more magnets, one or more latching features, or one or more hook and loop fasteners.

12. A fiber optic splice tray comprising:
a first base having first face;
a first splice organizer disposed on the first face of the first base, wherein the first splice organizer is configured to removably retain a first plurality of fiber optic splice connections;
a second base having a first face;
a second splice organizer disposed on a first face of the second base, wherein the second splice organizer is configured to removably retain a second plurality of fiber optic splice connections; and
a first hinge feature disposed at an edge of the first base or the second base;
wherein the first hinge feature pivotally connects the first base to the second base, such that the fiber optic splice tray is movable between an open position in which the first face of the first base and the first face of the second base are accessible and a closed position in which the first face of the first base confronts the first face of the second base limiting accessibility to the first face of the first base and the first face of the second base.

13. The fiber optic splice tray of claim 12, wherein the first base comprises a first fiber routing port disposed adjacent to the first hinge feature and the second base comprises a second fiber routing port disposed complementary to the first fiber routing port.

14. The fiber optic splice tray of either claim 12, wherein the first plurality of fiber optic splice connections and the second plurality of fiber optic splice connections comprise mass fusion splices.

15. The fiber optic splice tray of claim 12, wherein the first plurality of fiber optic splice connections comprises at least 144 splice connections and the second plurality of fiber optic splice connections comprises at least 144 splice connections.

16. The fiber optic splice tray of claim 12 further comprising:
a 288 fiber cable having a first portion and a second portion;
a first 144 fiber cable spliced to the first portion of the 288 fiber cable to form the first plurality of fiber optic splice connections; and
a second 144 fiber cable splice to the second portion of the 288 fiber cable to form the second plurality of fiber optic splice connections.

17. A fiber optic splice tray comprising:
a first base having first face;
a first splice organizer disposed on the first face of the first base, wherein the first splice organizer is configured to removably retain a first plurality of fiber optic splice connections;
a second base having a first face;
a second splice organizer disposed on a first face of the second base, wherein the second splice organizer is configured to removably retain a second plurality of fiber optic splice connections;
a first hinge feature disposed at an edge of the first base;
a hinge plate disposed between the first base and the second base; and
a second hinge feature disposed at an edge of the hinge plate,
wherein the first hinge feature pivotally connects the first base to the hinge plate and the second hinge feature pivotally connects the hinge plate to the second base, such that the fiber optic splice tray is movable between an open position in which the first face of the first base and the first face of the second base are accessible and a closed position in which the first face of the first base confronts the first face of the second base limiting accessibility to the first face of the first base and the first face of the second base.

18. The fiber optic splice tray of claim 17, wherein the first base comprises a first fiber routing port disposed adjacent to the first hinge feature and the second base comprises a second fiber routing port disposed complementary to the first fiber routing port.

19. The fiber optic splice tray of either claim 17, wherein the first plurality of fiber optic splice connections comprises at least 144 splice connections and the second plurality of fiber optic splice connections comprises at least 144 splice connections.

20. The fiber optic splice tray of claim 17 further comprising:
a 288 fiber cable having a first portion and a second portion;
a first 144 fiber cable spliced to the first portion of the 288 fiber cable to form the first plurality of fiber optic splice connections; and
a second 144 fiber cable splice to the second portion of the 288 fiber cable to form the second plurality of fiber optic splice connections.
